(19) United States
(12) Patent Application Publication
(10) Pub. No.: US 2016/0065101 A1
(43) Pub. Date: Mar. 3, 2016

(54) BLDC MOTOR CONTROL SYSTEM AND CONTROL METHOD

(71) Applicant: COAVIS, Sejong-si (KR)

(72) Inventors: Suk Min Yoon, Chungcheongbuk-do (KR); Young Sub Jang, Chungcheongbuk-do (KR)

(21) Appl. No.: 14/843,435

(22) Filed: Sep. 2, 2015

(30) Foreign Application Priority Data
Sep. 3, 2014 (KR) 10-2014-0117075

(51) Int. Cl. H02P 6/06

(52) U.S. Cl. CPC H02P 6/06

(57) ABSTRACT

Provided are a BLDC motor control system and a control method thereof. In more detail, the BLDC motor control system includes: a motor driver 100 driving a brushless DC (BLDC) motor; and a controller 200 sensing an RPM of the BLDC motor to generate a control signal for controlling the BLDC motor, in which the controller 200 may discriminate whether the RPM of the BLDC motor is a high RPM or a low RPM based on a preset reference RPM to generate the control signal.

### CROSS-REFERENCE TO RELATED APPLICATIONS

This application claims priority under 35 U.S.C. §119 to Korean Patent Application No. 10-2014-0117075, filed on Sep. 3, 2014, in the Korean Intellectual Property Office, the disclosure of which is incorporated herein by reference in its entirety.

### TECHNICAL FIELD

The following disclosure relates to a brushless DC (BLDC) motor control system and a control method thereof, and more particularly, to a BLDC motor control system which may be driven at highest efficiency in each section of revolutions per minute (RPM) by differently performing a pulse width modulation (PWM) control depending on a preset reference RPM by sensing the RPM of the BLDC motor, and a control method thereof.

### BACKGROUND

A small precision control motor is largely classified into an AC motor, a DC motor, a brushless DC (BLDC) motor, and a reluctance motor.

A small motor has firmly been established as a core part which dominates development and competitiveness of related products as a driving source and a control source for various kinds of electronic equipment and precision instruments since the number of control devices is increased as vehicles are getting more luxurious. For this purpose, a driving motor needs to be miniaturized, reduce noise and power consumption, etc.

The BLDC motor is a motor without a brush and a commutator and does not cause mechanical friction loss, spark, noise, etc., as a general rule and has an excellent RPM control or torque control. Further, the BLDC motor does not have a loss due to the RPM control and has excellent efficiency as a small motor.

In addition, the BLDC motor may be easily miniaturized and have robust durability and long lifespan since there is no need for maintenance. Therefore, the BLDC motor has been increasingly used for home appliances.

FIG. 1 is a control block diagram of the existing controller for a BLDC motor.

The existing controller for a BLDC motor 10 may include an inverter 70, a position sensor 20, and a PUM processor 50, in which the inverter converts a DC voltage applied from a bridge diode (not illustrated) into an AC voltage.

When the AC voltage is applied to the BLDC motor 10, a rotor of the BLDC motor 10 rotates and the position sensor 20 senses a position of the rotor whenever the rotor rotates to output a control signal to a driving signal generator 30 and an RPM controller 40.

The RPM controller 40 uses information on the position of the rotor transferred from the position sensor 20 to discriminate an RPM of the motor.

The driving signal generator 30 generates a predetermined signal to be able to let each transistor of the inverter perform an on/off switching operation and outputs the generated driving signal to the PWM processor 50 and the PWM processor 50 pulse-width-modulates the predetermined driving signal input from the driving signal generator 30 depending on the information on the RPM input from the RPM controller 40 and outputs the pulse-width-modulated driving signal to a gate driver 60.

The gate driver 60 supplies the pulse-width-modulated driving signal to the inverter and each transistor to let each transistor perform the on/off switching operation, such that each phase A, B, and C of each stator configuring the BLDC motor 10 may be supplied with the AC voltage to control the rotation of the BLDC motor 10.

However, when the BLDC motor 10 rotating at a high RPM by using the PWM control signal is used, a peak value of a phase current may be increased according to a high speed switching operation, which means that due to an increasing loss according to the switching, a larger radiating pipe is required or a rating of a device needs to be increased.

Therefore, the BLDC motor control system and the control method thereof according to the exemplary embodiment of the present invention may perform the pulse width modulation using a block wave (square wave) in a low RPM at the time of an initial driving of the BLDC motor to control the BLDC motor requiring a large torque due to an initial driving friction.

The BLDC motor control system and the control method thereof according to the exemplary embodiment of the present invention may perform the pulse width modulation using a sine wave in a high RPM to control the BLDC motor, thereby reducing noise and ripple.

Korean Patent Laid-Open Publication No. 10-2006-0118877 (“BLDC Motor Controller And Control Method Thereof”, hereinafter, referred to as Cited Document 1) discloses a BLDC motor controller and a control method thereof capable of minimizing torque and ripple generated when the BLDC motor rotates by making timing to switch a phase of AC power supplied to the BLDC motor different depending on predetermined conditions.

### RELATED ART DOCUMENT

### Patent Document

Korean Patent Laid-Open Publication No. 10-2006-0118877 (Published on Nov. 24, 2006)

### SUMMARY

An embodiment of the present invention is directed to providing a BLDC motor control system which may be driven at highest efficiency in each section of revolutions per minute (RPM) by differently performing a pulse width modulation (PWM) control depending on a preset reference RPM by sensing the RPM of the BLDC motor, and a control method thereof

In one general aspect, a BLDC motor control system includes: a motor driver 100 driving a brushless DC (BLDC) motor; and a controller 200 sensing an RPM of the BLDC motor to generate a control signal for controlling the BLDC motor, in which the controller 200 may discriminate whether the RPM of the BLDC motor is a high RPM or a low RPM based on a preset reference RPM to generate the control signal.

The controller 200 may include: an RPM discriminator 210 discriminating whether the RPM of the BLDC motor is the high RPM or the low RPM based on the preset reference RPM; and a signal generator 220 generating a pulse width modulation (PWM) control signal for controlling the driving of the BLDC motor depending on the discrimination result of the RPM discriminator 210 to control the driving of the BLDC motor.

The controller 200 may set a specific RPM among RPMs which are equal to or less than 50% of a maximum RPM of the BLDC motor as the reference RPM, such that if it is discriminated that the RPM of the BLDC motor is the low RPM, the controller controls the driving of the BLDC motor by a block wave (square wave) current waveform, and if it is discriminated that the RPM of the BLDC motor is the high RPM, the controller controls the driving of the BLDC motor by a sine wave current waveform.

In another general aspect, a control method of a BLDC motor includes: driving, by a motor driver, a BLDC motor (S100); and sensing, by a controller, an RPM of the BLDC motor to generate a control signal for controlling the BLDC motor based on a preset reference RPM (S200), in which the controlling (S200) includes: determining, by an RPM discriminator, whether the RPM of the BLDC motor is a high RPM or a low RPM based on the preset reference RPM (S210); and generating, by a signal generator, a pulse width modulation (PWM) control signal for controlling the driving of the BLDC motor depending on the discrimination result in the discriminating of the RPM to control the driving of the BLDC motor (S220).

In the controlling (S200), a specific RPM among RPMs which are equal to or less than 50% of a maximum RPM of the BLDC motor may be set as the reference RPM, such that if it is discriminated that the RPM of the BLDC motor is the low RPM, the driving of the BLDC motor may be controlled by a block wave (square wave) current waveform and if it is discriminated that the RPM of the BLDC motor is the high RPM, the driving of the BLDC motor may be controlled by a sine wave current waveform.

Other features and aspects will be apparent from the following detailed description, the drawings, and the claims.

### BRIEF DESCRIPTION OF THE DRAWINGS

FIG. 1 is a control block diagram of the existing BLDC motor controller.

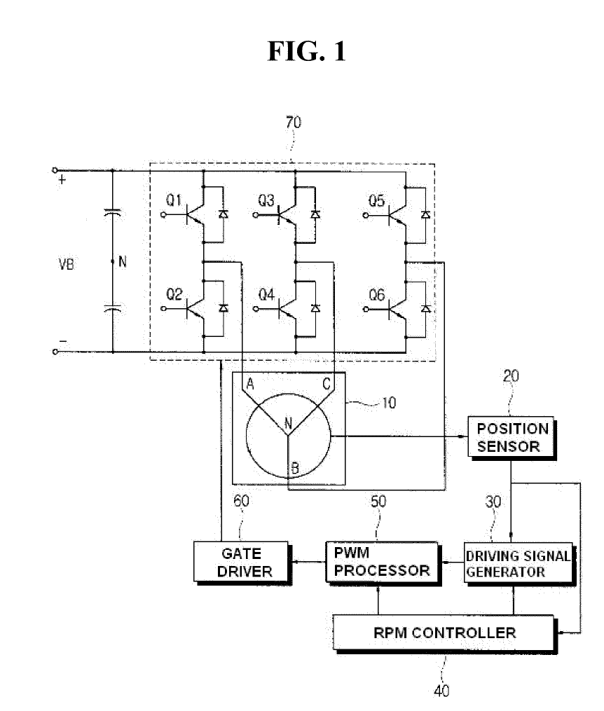

FIG. 2 is a diagram schematically illustrating a BLDC motor control system according to an exemplary embodiment of the present invention.

FIG. 3 is a diagram illustrating a control current waveform depending on an RPM of a BLDC motor by the BLDC motor control system according to the exemplary embodiment of the present invention.

FIG. 4 is a graph for setting a reference RPM for discriminating the RPM of the BLDC motor in the BLDC motor control system according to the exemplary embodiment of the present invention.

FIG. 5 is a flow chart illustrating a control method of a BLDC motor according to an exemplary embodiment of the present invention.

[Detailed Description of Main Elements]

| | |
|---|---|
| 100: Motor driver | |
| 200: Controller | |
| 210: RPM discriminator | 220: Signal generator |

### DETAILED DESCRIPTION OF EMBODIMENTS

Hereinafter, a BLDC motor control system and a control method thereof according to an exemplary embodiment of the present invention will be described in detail with reference to the accompanying drawings. The accompanying drawings to be provided below are provided by way of example so that the idea of the present invention can be sufficiently transferred to those skilled in the art to which the present invention pertains. Therefore, the present invention is not limited to the accompanying drawings to be provided below, but may be implemented in other forms. In addition, like reference numerals denote like elements throughout the specification.

Technical terms and scientific terms used in the present specification have the general meaning understood by those skilled in the art to which the present invention pertains unless otherwise defined, and a description for the known function and configuration unnecessarily obscuring the gist of the present invention will be omitted in the following description and the accompanying drawings.

In addition, the system means a set of components including apparatuses, mechanisms, units, etc., which are organized and regularly interact with each other to perform required functions.

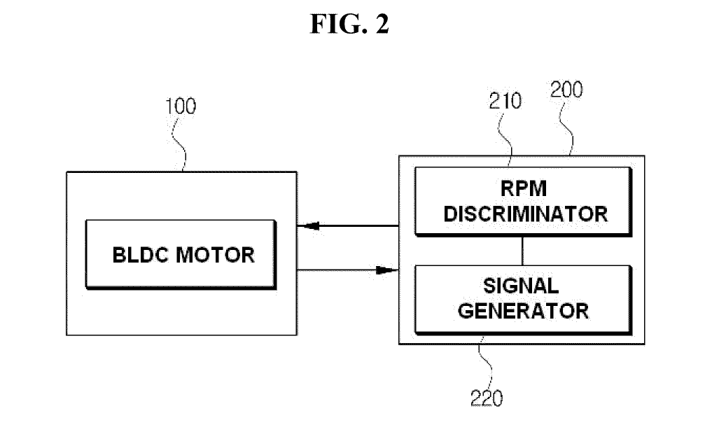

FIG. 2 is a configuration diagram schematically illustrating a BLDC motor control system according to an exemplary embodiment of the present invention. The configuration of the BLDC motor control system according to the exemplary embodiment of the present invention will be described in detail with reference to FIG. 2.

As illustrated in FIG. 2, the BLDC motor control system according to the exemplary embodiment of the present invention may be configured to include a brushless DC (BLDC) motor, a motor driver 100 driving the BLDC motor, and a controller 200 generating a control signal for controlling the BLDC motor.

Each component will be described below in detail.

As described above, the motor driver 100 may drive the BLDC motor and may receive a control signal of the BLDC motor from the controller 200 to perform a control.

The controller 200 may sense an RPM of the BLDC motor to generate the control signal for controlling the BLDC motor.

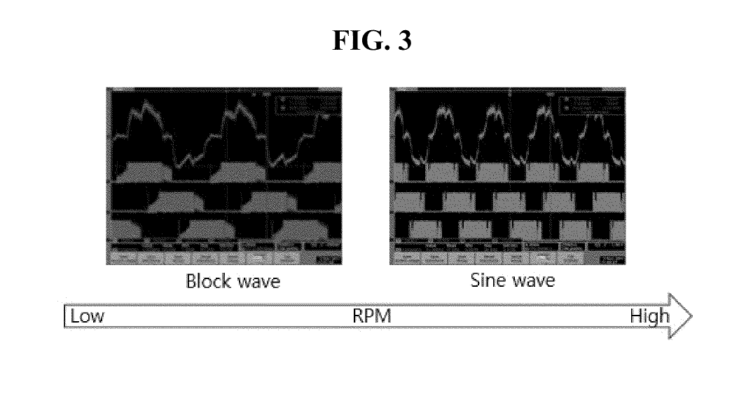

As illustrated in FIG. 3, the controller 200 may discriminate whether the RPM of the BLDC motor is a high RPM or a low RPM based on a preset reference RPM to generate different control signals.

The controller 200 may be configured to include an RPM discriminator 210 and a signal generator 220 and the RPM discriminator 210 may discriminate whether the RPM of the BLDC motor is the high RPM or the low RPM based on the preset reference RPM.

That is, if it is discriminated that the RPM of the BLDC motor is equal to or more than the preset reference RPM, it is discriminated that the RPM of the BLDC motor is the high RPM and if it is discriminated that the RPM of the BLDC motor is less than the preset reference RPM, it is discriminated that the RPM of the BLDC motor is the low RPM.

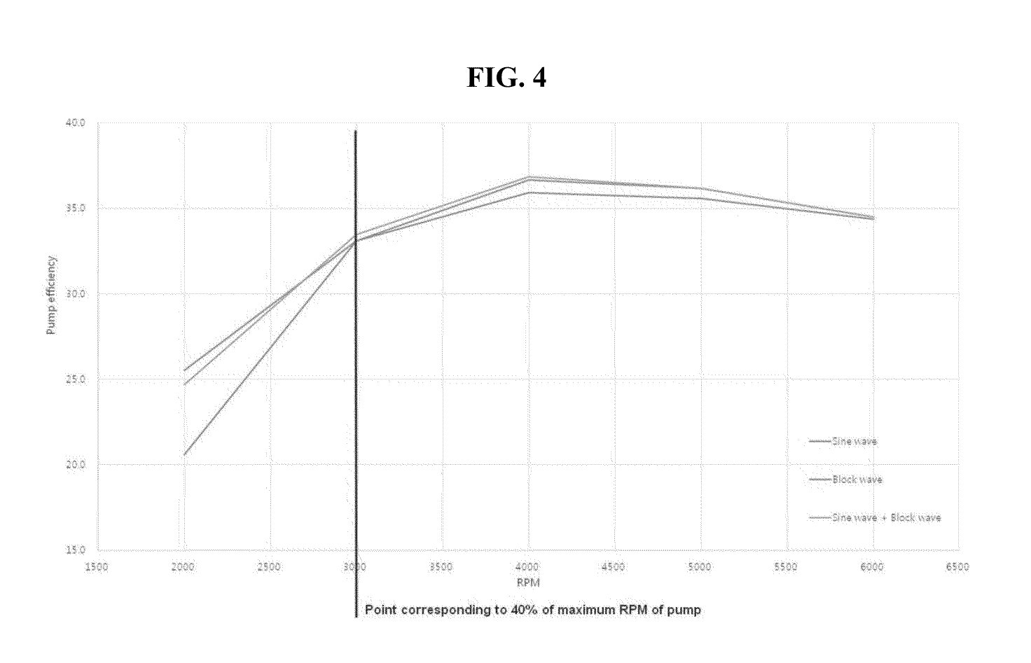

Here, the reference RPM may be set as a specific RPM among RPMs which are equal to or less than 50% of the maximum RPM of the BLDC motor, more preferably, an RPM corresponding to 40% of the maximum RPM. The setting of the reference RPM is only an example of the present invention. In addition, as illustrated in FIG. 4, the reference RPM may be set to optimize effects according to a block wave and a sine wave, and therefore the reference RPM may be differently set depending on the maximum RPM of the applied motor.

The signal generator 220 may generate different pulse width modulation (PWM) control signals for controlling the driving of the BLDC motor depending on the discrimination result of the RPM discriminator 210 to control the driving of the BLDC motor.

In detail, if it is discriminated that the RPM of the BLDC motor is less than the preset reference RPM, it is discriminated that the RPM of the BLDC motor is the low RPM, such that as illustrated in FIG. 3, the driving of the BLDC motor may be controlled by a block wave (square wave) current waveform.

Further, if it is discriminated that the RPM of the BLDC motor is equal to or more than the preset reference RPM, it is discriminated that the RPM of the BLDC motor is the high RPM, such that as illustrated in FIG. 3, the driving of the BLDC motor may be controlled by a sine wave current waveform.

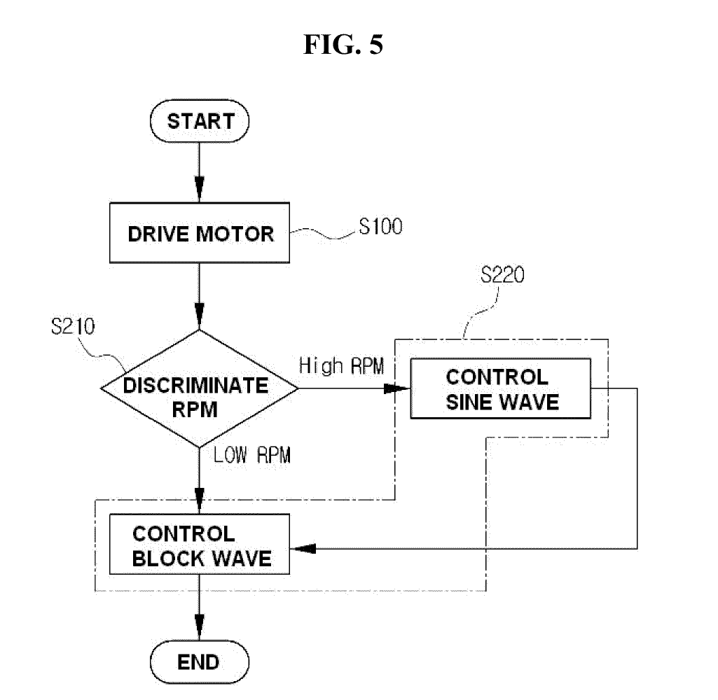

FIG. 5 is a flow chart illustrating a control method of a BLDC motor according to an exemplary embodiment of the present invention. A control method of a BLDC motor according to the exemplary embodiment of the present invention will be described in detail with reference to FIG. 5.

As illustrated in FIG. 5, the control method of the BLDC motor according to the exemplary embodiment of the present invention may include driving (S100) and controlling (S200) including discriminating an RPM (S210) and generating a signal (S220).

Each operation will be described below in detail.

In the driving (S100), the motor driver 100 drives the BLDC motor.

Briefly describing, in the controlling (S200), the controller 200 may sense the RPM of the BLDC motor to generate different control signals for controlling the BLDC motor based on the preset reference RPM.

In other words, the controlling (S200) may be configured to include the discriminating of the RPM (S210) and the generating of the signal (S220).

In the discriminating of the RPM (S210), the RPM discriminator 210 may discriminate whether the RPM of the BLDC motor is the high RPM or the low RPM based on the preset reference RPM.

In detail, if it is discriminated that the RPM of the BLDC motor is equal to or more than the preset reference RPM, it is discriminated that the RPM of the BLDC motor is the high RPM and if it is discriminated that the RPM of the BLDC motor is less than the preset reference RPM, it is discriminated that the RPM of the BLDC motor is the low RPM. Here, the reference RPM may be set as a specific RPM among RPMs which are equal to or less than 50% of the maximum RPM of the BLDC motor, more preferably, an RPM corresponding to 40% of the maximum RPM. The setting of the reference RPM is only an example of the present invention. In addition, as illustrated in FIG. 4, the reference RPM may be set to optimize effects according to a block wave and a sine wave, and therefore the reference RPM may be differently set depending on the maximum RPM of the applied motor.

In the generating of the signal (S220), the signal generator 220 may generate different pulse width modulation (PWM) control signals for controlling the driving of the BLDC motor depending on the discrimination result in the discriminating of the RPM (S210) to control the driving of the BLDC motor.

In detail, as the discrimination result in the discriminating of the RPM (S210), if it is discriminated that the RPM of the BLDC motor is less than the preset reference RPM, it is discriminated that the RPM of the BLDC motor is the low RPM, such that as illustrated in FIG. 3, the driving of the BLDC motor may be controlled by the block wave (square wave) current waveform.

On the contrary, as the discrimination result in the discriminating of the RPM (S210), if it is discriminated that the RPM of the BLDC motor is equal to or more than the preset reference RPM, it is discriminated that the RPM of the BLDC motor is the high RPM, such that as illustrated in FIG. 3, the driving of the BLDC motor may be controlled by the sine wave current waveform.

In other words, the BLDC motor control system and the control method thereof according to the exemplary embodiment of the present invention do not cause large noise when the BLDC motor is initially driven, but require a large torque due to the friction and therefore control the BLDC motor using the block wave, thereby increasing the torque and increasing the efficiency of the BLDC motor in response to the increase in the torque.

Further, the BLDC motor causes the large noise in the high RPM section but does not require the larger torque due to the friction than at the time of the initial driving of the BLDC motor, and therefore the BLDC motor is controlled using the sine wave, thereby reducing noise and ripple.

According to the exemplary embodiments of the present invention, the BLDC motor control system and the control method thereof may sense the RPM of the brushless DC (BLDC) motor to discriminate whether the RPM of the BLDC motor is a high RPM or a low RPM depending on the preset reference RPM so as to differently perform the pulse width modulation (PWM) control depending on the discrimination, such that the BLDC motor control system may be driven at the highest efficiency in each section of the RPM.

In this case, if it is discriminated that the RPM of the BLDC motor is the low RPM, it is discriminated that the BLDC motor requiring the large torque due to a friction is in the initial driving, such that the driving of the BLDC motor may be controlled by the block wave current waveform, thereby increasing the driving torque of the BLDC motor.

If it is discriminated that the RPM of the BLDC motor is the high RPM, the BLDC motor does not require a torque larger than at the time of the initial driving of the BLDC motor to control the driving of the BLDC motor using the sine wave current waveform, thereby reducing the noise and the ripple.

As a result, it is possible to differently generate the control signal to meet each RPM to reduce the noise and perform the smooth driving.

Hereinabove, although the present invention has been described by specific matters such as detailed components, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention

What is claimed is:

1. A BLDC motor control system, comprising:
a motor driver driving a brushless DC (BLDC) motor; and
a controller sensing an RPM of the BLDC motor to generate a control signal for controlling the BLDC motor,
wherein the controller discriminates whether the RPM of the BLDC motor is a high RPM or a low RPM based on a preset reference RPM to generate the control signal.

2. The BLDC motor control system of claim 1, wherein the controller includes:
an RPM discriminator discriminating whether the RPM of the BLDC motor is the high RPM or the low RPM based on the preset reference RPM; and
a signal generator generating a pulse width modulation (PWM) control signal for controlling the driving of the BLDC motor depending on the discrimination result of the RPM discriminator to control the driving of the BLDC motor.

3. The BLDC motor control system of claim 2, wherein the controller sets a specific RPM among RPMs which are equal to or less than 50% of a maximum RPM of the BLDC motor as the reference RPM, such that if it is discriminated that the RPM of the BLDC motor is the low RPM, the controller controls the driving of the BLDC motor by a block wave (square wave) current waveform and if it is discriminated that the RPM of the BLDC motor is the high RPM, the controller controls the driving of the BLDC motor by a sine wave current waveform.

4. A control method of a BLDC motor, comprising:
driving, by a motor driver, a BLDC motor; and
sensing, by a controller, an RPM of the BLDC motor to generate a control signal for controlling the BLDC motor based on a preset reference RPM,
wherein the controlling includes determining, by an RPM discriminator, whether the RPM of the BLDC motor is a high RPM or a low RPM based on the preset reference RPM; and
generating, by a signal generator, a pulse width modulation (PWM) control signal for controlling the driving of the BLDC motor depending on the discrimination result in the discriminating of the RPM to control the driving of the BLDC motor.

5. The control method of claim 4, wherein in the controlling, a specific RPM among RPMs which are equal to or less than 50% of a maximum RPM of the BLDC motor is set as the reference RPM, such that if it is discriminated that the RPM of the BLDC motor is the low RPM, the driving of the BLDC motor is controlled by a block wave (square wave) current waveform and if it is discriminated that the RPM of the BLDC motor is the high RPM, the driving of the BLDC motor is controlled by a sine wave current waveform.
